(19) United States
(12) Patent Application Publication
(10) Pub. No.: US 2024/0154858 A1
(43) Pub. Date: May 9, 2024

(54) ALARM CORRELATION SYSTEM AND METHOD OF USING

(71) Applicant: Rakuten Symphony Singapore Pte. Ltd., Singapore (SG)

(72) Inventors: Nimit AGRAWAL, Madhya Pradesh (IN); Akash SONI, Madhya Pradesh (IN)

(21) Appl. No.: 17/773,006

(22) PCT Filed: Mar. 28, 2022
(86) PCT No.: PCT/US2022/022145

§ 371 Date: Apr. 28, 2022

(51) Int. Cl. H04L 41/069; H04L 41/0631

(52) U.S. Cl. CPC H04L 41/069; H04L 41/0631

(57) ABSTRACT

A system for identifying correlated alarms includes a non-transitory computer readable medium configured to store instructions thereon; and a processor connected to the non-transitory computer readable medium. The processor is configured to execute the instructions for identifying a parent alarm from an alarm log based a plurality of rules, wherein the alarm log comprises a plurality of alarm, and the plurality of alarms contains the identified parent alarm. The processor is configured to execute the instructions for determining whether the plurality of alarms includes a child alarm associated with the identified parent alarm based on the plurality of rules. The processor is configured to execute the instructions for generating an incident in response to a determination that the plurality of alarms includes the child alarm, wherein the incident includes instructions for resolving the parent alarm.

### FIELD

This application relates to an alarm correlation system and a method of using an alarm correlation system.

### BACKGROUND

When an alarm is generated in a network a fault which cause the alarm will also cause additional alarms in some instances. For example, a power outage in a router will cause an alarm indicating a power outage and also cause an alarm indicating a lack of connection for the router. In some instances, this relationship is called a parent-child alarm relationship. For example, the power outage is a parent alarm and the lack of connection is a child alarm. As a network expands, more equipment is added to the network and a number of alarms generated also increases. The increased number of alarms results in a large amount of data for analysis in determining how to repair the network.

### SUMMARY

An aspect of this description relates to a system for identifying correlated alarms. The system includes a non-transitory computer readable medium configured to store instructions thereon; and a processor connected to the non-transitory computer readable medium. The processor is configured to execute the instructions for identifying a parent alarm from an alarm log based a plurality of rules, wherein the alarm log comprises a plurality of alarm, and the plurality of alarms contains the identified parent alarm. The processor is configured to execute the instructions for determining whether the plurality of alarms includes a child alarm associated with the identified parent alarm based on the plurality of rules. The processor is configured to execute the instructions for generating an incident in response to a determination that the plurality of alarms includes the child alarm, wherein the incident includes instructions for resolving the parent alarm. In some embodiments, the processor is further configured to execute the instructions for receiving the alarm log; and receiving the plurality of rules. In some embodiments, the processor is further configured to execute the instructions for receiving the plurality of rules from a user. In some embodiments, the processor is further configured to execute the instructions for identifying a plurality of parent alarms from the alarm log based on the plurality of rules. In some embodiments, the processor is further configured to execute the instructions for selecting a target parent alarm from the plurality of parent alarms based on the determination of whether the plurality of alarms includes the child alarm; and generating the incident for resolving the target parent alarm. In some embodiments, the processor is further configured to execute the instructions for selecting the target parent alarm based on a number of child alarms, determined to be in plurality of alarms, associated with each of the plurality of parent alarms, wherein the target parent alarm has a highest number of child alarms amongst the plurality of parent alarms. In some embodiments, the processor is further configured to execute the instructions for selecting the target parent alarm based on a percentage of child alarms, determined to be in plurality of alarms, associated with each of the plurality of parent alarms, wherein the target parent alarm has a highest percentage of child alarms amongst the plurality of parent alarms. In some embodiments, the processor is further configured to execute the instructions for selecting the target parent alarm based on a time that each of the plurality of parent alarms was initiated. In some embodiments, the processor is further configured to execute the instructions for aggregating the plurality of alarms based on the alarm log.

An aspect of this description relates to a method of identifying correlated alarms. The method includes identifying a parent alarm from an alarm log based a plurality of rules, wherein the alarm log comprises a plurality of alarm, and the plurality of alarms contains the identified parent alarm. The method further includes determining whether the plurality of alarms includes a child alarm associated with the identified parent alarm based on the plurality of rules. The method further includes generating an incident in response to a determination that the plurality of alarms includes the child alarm, wherein the incident includes instructions for resolving the parent alarm. In some embodiments, the method further includes receiving the alarm log; and receiving the plurality of rules. In some embodiments, receiving the rule includes receiving the plurality of rules from a user. In some embodiments, the method further includes identifying a plurality of parent alarms from the alarm log based on the plurality of rules; selecting a target parent alarm from the plurality of parent alarms based on the determination of whether the plurality of alarms includes the child alarm; and generating the incident for resolving the target parent alarm. In some embodiments, selecting the target parent alarm includes selecting the target parent alarm based on a number of child alarms, determined to be in plurality of alarms, associated with each of the plurality of parent alarms, wherein the target parent alarm has a highest number of child alarms amongst the plurality of parent alarms. In some embodiments, selecting the target parent alarm includes selecting the target parent alarm based on a percentage of child alarms, determined to be in plurality of alarms, associated with each of the plurality of parent alarms, wherein the target parent alarm has a highest percentage of child alarms amongst the plurality of parent alarms. In some embodiments, selecting the target parent alarm includes selecting the target parent alarm based on a time that each of the plurality of parent alarms was initiated.

An aspect of this description relates to a non-transitory computer readable medium configured to store instructions thereon. The instructions when executed by a process cause the processor to identify a parent alarm from an alarm log based a plurality of rules, wherein the alarm log comprises a plurality of alarm, and the plurality of alarms contains the identified parent alarm. The instructions when executed by a process cause the processor to determine whether the plurality of alarms includes a child alarm associated with the identified parent alarm based on the plurality of rules. The instructions when executed by a process cause the processor to generate an incident in response to a determination that the plurality of alarms includes the child alarm, wherein the incident includes instructions for resolving the parent alarm. In some embodiments, the instructions are further configured to cause the processor to identify a plurality of parent alarms from the alarm log based on the plurality of rules; select a target parent alarm from the plurality of parent alarms based on the determination of whether the plurality of alarms includes the child alarm; and generate the incident for resolving the target parent alarm. In some embodiments, the instructions are further configured to cause the processor to select the target parent alarm based on a number of child alarms, determined to be in plurality of alarms, associated with each of the plurality of parent alarms, wherein the target parent alarm has a highest number of child alarms amongst the plurality of parent alarms. In some embodiments, the instructions are further configured to cause the processor to select the target parent alarm based on a percentage of child alarms, determined to be in plurality of alarms, associated with each of the plurality of parent alarms, wherein the target parent alarm has a highest percentage of child alarms amongst the plurality of parent alarms.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a view of a telecommunication network in accordance with some embodiments.

FIG. 2 is a flowchart of a method of correlating alarms in accordance with some embodiments.

FIG. 3 is a diagram of a system for correlating alarms in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

A telecommunication network contains numerous interconnected elements. In some instances, a fault or error, also called an alarm, in one component results in a second alarm in the same component or a different component. A network monitor receives an alarm log of the alarms generated within the telecommunication network. The alarm log includes both the initial alarm as well as the second alarm. Any effort put forth to resolving the second alarm without also resolving the initial alarm will be wasted or inefficient due to the correlation between the initial alarm and the second alarm.

In order to help reduce or avoid wasted or inefficient effort, the current description describes a method and system for correlating the alarms. In some instances, the correlated alarms are called parent alarms and child alarms, where the parent alarm is a root cause of a child alarm. Based on the correlation between the parent alarms and child alarms, a network monitor is able to analyze data from an alarm log to identify which of the alarms are child alarms. Identifying the child alarms allows the network monitor to assign or perform work for repairing the telecommunication network to parent alarms in a prioritized manner. In some instances, resolving the parent alarm will automatically resolve a corresponding one or more child alarms. In some instances, resolving the parent alarm will reduce the effort used for resolving the corresponding one or more child alarms. As a result, a total amount of effort in maintaining or repairing the telecommunication network is reduced by correlating the alarms.

In some instances, the method and system describe herein is able to generate a combined incident report that includes work for resolving both a parent alarm and the corresponding one or more child alarms. For example, in some instances, a first component will generate a parent alarm, which causes a child alarm in a second component different from the first component. An incident report would include instructions for replacing or repairing the first component. In some instances, the replacement or repair of the first component will resolve both the parent alarm and the child alarm. However, in some instances, an additional operation such as restarting of the second component is used to resolve the child alarm. By including instructions for resolving both the parent alarm and the child alarm in a same incident report, an amount of resources, i.e., time, money, or effort, used to resolve both alarms is reduced in comparison to an approach where each of the parent alarm and the child alarm are addressed separately.

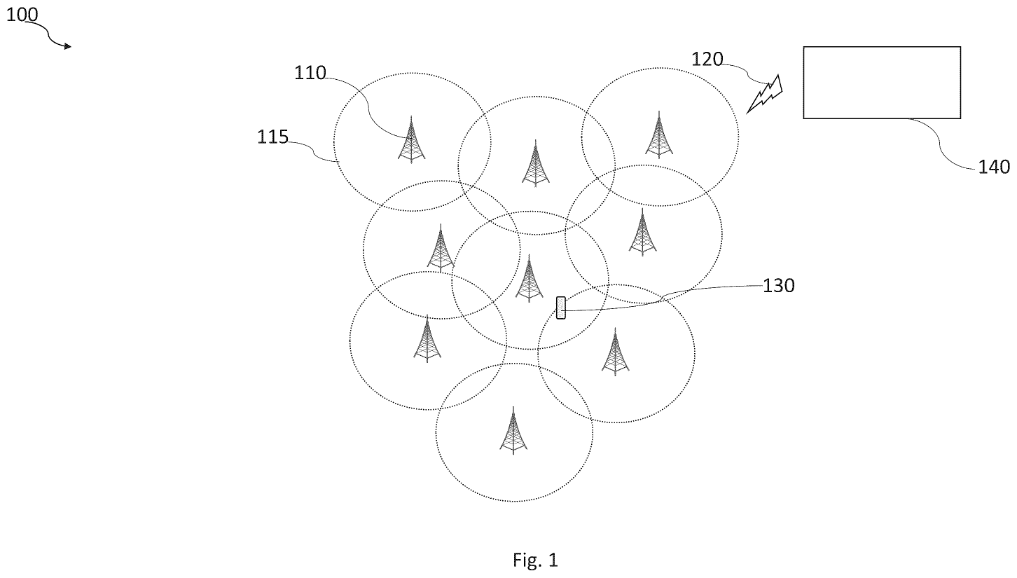

FIG. 1 is a diagram of a telecommunication network 100 in accordance with some embodiments. The telecommunication network 100 includes a plurality of base stations 110 and each base station 110 has a corresponding coverage area 115. In some instances, cover areas 115 for neighboring base stations 110 overlap one another to define an overlapping coverage area. In some instances, a gap exists between coverage areas 115 of neighboring base stations 110. A mobile device 130 within the telecommunication network 100 is able to connect to one or more base station 110 when the mobile device 130 is within the coverage area 115 corresponding to the base station 110. A connection 120 is used to provide data, such as an alarm log, from the base stations 110 to a monitoring system 140. The monitoring system 140 is usable to monitor performance of the base stations 110 to help maintain a high quality service provided by the telecommunication network 100. In some embodiments, the connection 120 is a wireless connection. In some embodiments, the connection 120 is a wired connection.

A telecommunication service provider is responsible for maintaining the base stations 110 and minimizing a size and number of gaps in the coverage areas 115 of the telecommunication network 100. In some embodiments, the service provider becomes aware of a connectivity issue with the mobile device 130. In some embodiments, the service provider becomes aware of the connectivity issue through communication with a user of the mobile device 130. In some embodiments, the service provider becomes aware of the connectivity issue through monitoring of key performance indicators (KPIs) within the telecommunication network 100, or through other monitored parameters. If the mobile device 130 is within a gap of coverage areas 115, the service provider is likely to provide instructions for service or maintenance of one of more base stations 110 adjacent to the gap in order to reduce or remove the gap from the telecommunication network 100.

Using the connection 120 to monitor the performance of the base stations 110, the monitoring system 140 is able to collect data from the base stations 110, such as alarm logs. An alarm log includes historical information related to error or problems within the base station. The alarm log includes information such as an alarm code, which indicates what type of problem or error occurred, a time that the alarm was initially generated, a time at which the alarm ceased, or other suitable information. In some embodiments, the alarm log is received in response to a request issued by the monitoring system 140 to each of the base stations 110. In some embodiments, alarms are continually transmitted to the monitoring system 140 over the connection 120 and an alarm log is stored in the monitoring system 140.

In response to receiving an alarm, a user, such as a system monitor, is able to review the alarm, determine a process for resolving the problem or error, and issuing instructions to begin a resolution process. In some embodiments, the instructions include instructions transmitted directly to the base station 110 over the connection 120. Instructions such as restart commands, reset commands, software updates, or the like are able to be transmitted directly to the base station 110 to help resolve the problem or error. In some embodiments, the instructions are transmitted to a maintenance crew in order to physically address a problem at the base station 110. Instructions such as repair equipment, replace equipment, install new equipment, or the like are issued to maintenance crews that are then able to implement the instructions for helping to resolve the problem or error.

While the ability for the user to view and issue instructions for resolving an alarm is practical for many types of alarm, some alarms are a result of a fault or error in another component; or a result from a different fault or error within a same component of the telecommunication network 100. These types of alarms are called correlated alarms. In some instances, an alarm which triggers another alarm is called a parent alarm, and the triggered alarm is called a child alarm. The user viewing an alarm log without information related to correlated alarms has a higher risk of issuing instructions to resolve an alarm, which is a child alarm, without knowing about a relationship that exists between the alarm and another alarm. Instructions issued for resolving a child alarm without addressing a corresponding parent alarm have a higher risk of not being able to resolve the child alarm or spending a large amount of time to discover a cause of the child alarm. In order to help reduce the risk of inefficient alarm resolution instructions, the monitoring system 140 is configured to correlate alarms in the alarm log. Based on the correlation, the system monitor is able to identify relationships between alarms and issue instructions for more efficiently resolving the alarms. In some embodiments, the system monitor is able to issue a single incident report that includes instructions for resolving both the parent alarm and one or more child alarms.

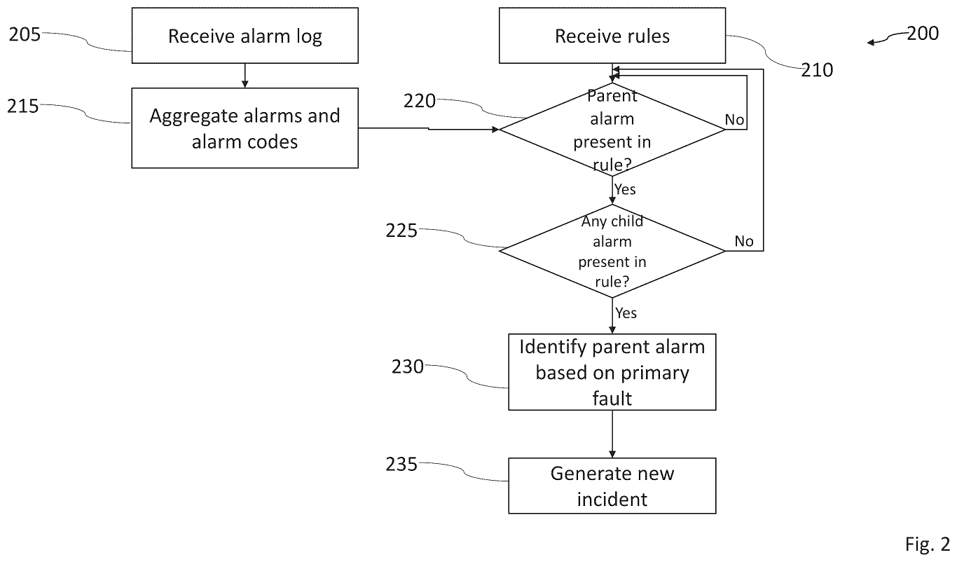

In some embodiments, in order to help identify correlated alarms, the monitoring system 140 is configured to perform the method 200 (FIG. 2). Using the method 200, the monitoring system 140 is able to identify correlated alarms and issue instructions for resolution of the problem or error to address the correlated alarms. In some embodiments, the monitoring system 140 is configured to identify correlated alarms from the alarm log based on correlation rules. In some embodiments, the correlation rules are stored within the monitoring system 140. In some embodiments, the correlation rules are stored separate from the monitoring system 140; and the monitoring system 140 is configured to receive the correlation rules either wirelessly or through a wired connection.

In some embodiments, the monitoring system 140 is configured to display an interface, such as a graphical user interface (GUI), for receiving input information from the user. In some embodiments, the monitoring system 140 is configured to receive correlation rule information from the user. The correlation rule information is usable to define rules for identifying problems or errors within the telecommunication network 100 that are related to other problems or errors within the telecommunication network 100. In some embodiments, the correlation rule information includes a domain, a vendor, a primary fault (parent alarm), one or more secondary faults (child alarms), or other suitable information. In some embodiments, the correlation rules include information directed to relationships between alarm codes. In some embodiments, the correlation rules do not include information related to alarm codes.

Using the correlation rule information, the monitoring system 140 is able to review alarm logs to identify alarms which are related to one another. The user is then able to use the monitoring system 140 to issue instructions for resolving the parent alarm. In some embodiments, the user is able to issue instructions for resolving the parent alarm as well as one or more child alarms.

In some embodiments, the monitoring system 140 is configured to identify potential relationships between alarms based on a timing of alarms within an alarm log. For example, in some embodiments, the monitoring system 140 is able to use machine learning to determine that a first alarm, having a first alarm code, initiated at a first time is often followed by a second alarm, having a second alarm code, initiated at a second time that is a certain time period after the first time. Based on the recognition of such a pattern, the monitoring system 140 is able to suggest a potential relationship between the first alarm and the second alarm, in some embodiments. In some embodiments, the monitoring system 140 is configured to group alarms that occur within a certain time period together and provide a suggestion that a relationship between the grouped alarms is possible. In some embodiments, the monitoring system 140 is configured to automatically provide the potentially related alarms to the user. In some embodiments, the monitoring system 140 is further configured to provide potentially related alarms in response to receiving a request from the user. In some embodiments, the user is able to select among the grouped alarms in order to establish a new correlation rule. In some embodiments, the user input is received via the GUI.

In response to identifying correlated alarms, the monitoring system 140 is configured to generate an incident report. An incident report identifies the correlated alarms and includes instructions for attempting to resolve the identified parent alarm. In some embodiments, the incident report further includes instructions for attempting to resolve one or more identified child alarms. In some embodiments, the monitoring system 140 is configured to compare the generated incident report with currently open incident reports in order to determine whether to issue the instructions associated with the incident report. An open incident report means that an incident report has been generated, but the instructions for resolving the underlying alarm have not yet been implemented. In some embodiments, in response to a determination that the incident report matches an open incident report, the monitoring system 140 is configured to discard the most recently generated incident report. In some embodiments, in response to a determination that the incident report matches an open incident report, the monitoring system 140 is configured to increase a priority level of the previously generated incident report. In some embodiments, in response to a determination that no incident report matches the generated incident report, the monitoring system 140 is configured to issue the instructions associated with the incident report. In some embodiments, the instructions include an alert. In some embodiments, the alert includes an audio or visual alert. In some embodiments, the instructions cause a device receiving the instructions, such as a mobile device, to automatically display the alert in response to receiving the instructions.

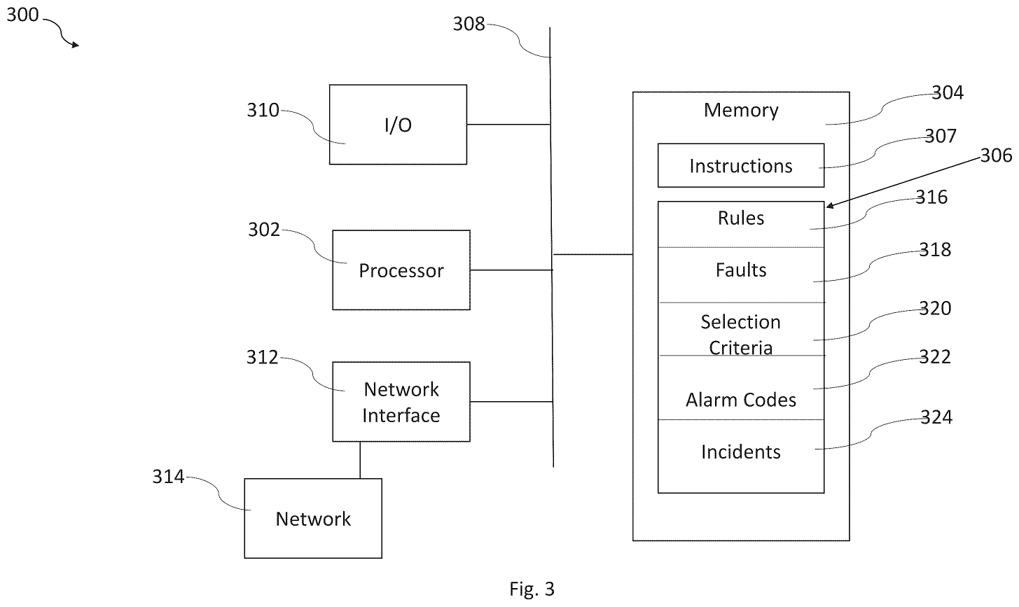

FIG. 2 is a flowchart of a method 200 of identifying recurring alarms in accordance with some embodiments. In some embodiments, the method 200 is implemented using the monitoring system 140 (FIG. 1). In some embodiments, the method 200 is implemented using the system 300 (FIG. 3). The method 200 assists in the identification of correlated alarms within a telecommunication network, such as telecommunication network 100 (FIG. 1), in order to help improve efficiency of alarm resolution to improve the performance of the telecommunication network.

In operation 205, an alarm log is received. In some embodiments, the alarm log is received from one or more base stations, e.g., base stations 110 (FIG. 1), connected to a monitoring system, e.g., monitoring system 140 (FIG. 1). In some embodiments, alarms are received from one or more base stations, e.g., base stations 110 (FIG. 1), connected to the monitoring system, e.g., monitoring system 140 (FIG. 1), and the monitoring system is configured to store the alarms in an alarm log. In some embodiments, the alarm log is received wirelessly. In some embodiments, the alarm log is received via a wired connection. The alarm log includes information related to errors or problems, also called faults, within the telecommunication system. The alarm log includes time information indicating when the alarm was initiated. In some embodiments, the alarm log further includes alarm code information identifying the fault which caused the alarm. In some embodiments, the alarm log includes information related to when the alarm ceased. In some embodiments, the alarm log includes a table format. In some embodiments, the alarm log is searchable.

In some embodiments, the alarm log is received automatically at predetermined intervals. In some embodiments, the predetermined intervals are set based on a determined quality of service of the telecommunication network determined based on one or more measured KPIs of the telecommunication network. For example, in some embodiments, in response to a determination that the telecommunication network is operating at a high quality of service, the predetermined intervals are longer than when the telecommunication network is operating at a low quality of service. Factoring the quality of service of the telecommunication network into the predetermined interval helps to improve efficiency of monitoring and maintaining the telecommunication network. In a situation where the quality of service is low, customer satisfaction is more likely to be negatively impacted. Therefore, a more rapid response is desired in order to maintain or improve customer satisfaction with the telecommunication network. On the contrary, when the quality of service of the telecommunication network is high, spending resources on repair or replacement operations is inefficient.

In operation 210, one or more rules are received. In some embodiments, the rules are received based on user input at the monitoring system, e.g., the monitoring system 140 (FIG. 1). For example, in some embodiments, the user is able to enter criteria for identifying a correlated alarms into a GUI of the monitoring system 140. In some embodiments, the rule includes a domain, a vendor, a primary fault (parent alarm), one or more secondary fault (child alarm), or other suitable information. The domain indicates a location of a fault causing the alarm within the telecommunication network. For example, in some embodiments, the domain includes a core, a radio access network (RAN), or another suitable domain. The vendor indicates the entity that is responsible for providing or maintaining the telecommunication network. In some embodiments, the vendor includes a service provider. In some embodiments, the vendor includes a third party contracted by the service provider to maintain the telecommunication network. The primary fault includes the parent alarm that triggers the one or more child alarms. In some embodiments, the primary fault is identified by an alarm code. The alarm code is an indication of a type of fault occurring within the telecommunication system. The one or more secondary faults include one or more child alarms triggered by the parent alarm. In some embodiments, the secondary fault is identified by an alarm code. In some embodiments, all of the secondary faults are within a same component of the telecommunication network as the primary fault. In some embodiments, at least one secondary fault is within a different component of the telecommunication network from the component including the primary fault. A sample rule for correlated alarms includes domain data indicating a core domain; vendor data indicating a service provider; a primary fault indicating a power failure; and two secondary faults indicating a link down and an instance down. Based on such a rule, the monitoring system would be able to search the alarm log for alarms which satisfy the criteria defined by the rule. Another sample rule for correlated alarms includes a primary fault indicated an extreme temperature; and two secondary faults indicated a cell being down and a cooling fan failure. Based on such a rule, the monitoring system would be able to search the alarm log and correlate an alarm for the extreme temperature with the alarms indicating the cell being down and the cooling fan failing. Another sample rule for correlated alarms includes a primary fault indicating an instance down; and two secondary faults indicating a hypervisor being down and a link being down. Based on such a rule, the monitoring system would be able to search the alarm log and correlate an alarm for the instance being down with alarms for the hypervisor and link both being down. One of ordinary skill in the art would recognize that a hypervisor is an example of a virtual machine monitor for creating and running virtual machines.

In some embodiments, the monitoring system recommends at least a portion of the rule based on an analysis of the alarm log. For example, in some embodiments, in response to the monitoring system identifying a pattern of an alarm occurring shortly after a different alarm, the monitoring system suggests a potential relationship to the user. In some embodiments, the recommendation from the monitoring system includes an alert, such as an audio or visual alert. In some embodiments, the recommendation causes the alert to automatically appear on a device, such as a mobile device, accessible by the user. In some embodiments, the alert includes an ability of the user to accept or decline the recommendation.

In some embodiments, in response to receiving a potential relationship, the monitoring system is further configured to recommend information such as vendor or domain information to the user. For example, in response to identifying an alarm indicating a power failure, the monitoring system suggests a domain of core.

In operation 215, the alarms from the alarm log are aggregated with the corresponding alarm codes over a predetermined review period. The predetermined review period is a duration over which the alarm log spans. In some embodiments, the predetermined review period is determined based on an acceptable processing load on the monitoring system, e.g., monitoring system 140 (FIG. 1). In some embodiments, the predetermined review period ranges from about 12 hours to about 1 week. In some embodiments, the predetermined review period is set by the user, e.g., by entering information into the monitoring system. In some embodiments, the monitoring system is configured to recommend a predetermined view period based on a processing load of the monitoring system.

In some embodiments, the predetermined review period is based on a duration for which alarm log data is available. For example, in some embodiments, due to memory storage capacity, the alarm log data is overwritten after a predetermined time lapse; and the predetermined review period is set to be shorter than the predetermined time lapse to help maintain precision of the correlation in operation 215.

In operation 220, the aggregated alarms from the operation 215 are compared with the received rules from operation 210 to determine whether any parent alarms are present in the aggregated alarms. The aggregated alarms are compared with the rules to determine whether any of the aggregated alarms match a primary fault in the received rules. In some embodiments, the parent alarms are identified based on alarm codes. In some embodiments, the parent alarms are identified based on a criterion other than the alarm codes. In response to a determination that a parent alarm is present in the aggregated alarms, the method 200 proceeds to operation 225. In response to a determination that no parent alarm exists in the aggregated alarms, the method 220 repeats operation 220 and waits for a new set of aggregated alarms. In some embodiments, in response to a determination that no parent alarms match any of the received rules, the method 200 pauses and is implemented again at a later time following a predetermined delay interval; in response to receiving a new rule from the user; in response to a request from the user to implement the method 200 again; or in response to another suitable condition. In some embodiments, the predetermined delay interval is based on a processing load of the monitoring system, e.g., monitoring system 140 (FIG. 1).

In operation 225, the aggregated alarms from the operation 215 are compared with the received rules from operation 210 to determine whether any child alarms are present in the aggregated alarms. The aggregated alarms are compared with the rules to determine whether any of the aggregated alarms match one or more secondary fault related to a primary fault identified in operation 220 in the received rules. In some embodiments, the child alarms are identified based on alarm codes. In some embodiments, the child alarms are identified based on a criterion other than the alarm codes. In response to a determination that a child alarm related to a parent alarm identified in operation 220 is present in the aggregated alarms, the method 200 proceeds to operation 230. In some embodiments, multiple child alarms are related to a single parent alarm. If any one of the multiple child alarms related to a parent alarm identified in operation 220 is identified in operation 225, the condition of the operation 225 is deemed satisfied and the method 200 proceeds to operation 230. In some embodiments, a child alarm is associated with multiple parent alarms. If any of the child alarm identified in operation 225 corresponds to any parent alarm identified in operation 220, the method 200 proceeds to operation 230. In response to a determination that no child alarm is related to the parent alarm identified in operation 220 exists in the aggregated alarms, the method 220 repeats operation 220 and waits for a new set of aggregated alarms. In some embodiments, in response to a determination that no child alarms are related to an identified parent alarm matches any of the received rules, the method 200 pauses and is implemented again at a later time following a predetermined delay interval; in response to receiving a new rule from the user; in response to a request from the user to implement the method 200 again; or in response to another suitable condition. In some embodiments, the predetermined delay interval is based on a processing load of the monitoring system, e.g., monitoring system 140 (FIG. 1).

In operation 230, a parent alarm to be resolved is identified based on the primary fault from the rules received in operation 210. In some embodiments, the parent alarm to be resolved is determined based on the parent alarm identified in operation 220. In some embodiments, the parent alarm to be resolved is determined based on the one or more child alarms identified in operation 225.

In some embodiments, multiple parent alarms are identified in operation 220. In some embodiments, child alarms associated with more than one parent alarm are identified in operation 225. In a situation where more than one parent alarm was identified in operation 220 or operation 225, the parent alarm to be resolved is determined based on a number of child alarms identified in operation 225 associated with each of the identified parent alarms. For example, in some embodiments, a first parent alarm and a second parent alarm are identified in operation 220. Then, in operation 225, two child alarms related to the first parent alarm are identified and three child alarms related to the second parent alarm are identified. In such a situation, the parent alarm to be resolved is determined to be the second parent alarm.

In the above example, the determination between multiple parent alarms is based on absolute numbers of identified child alarms associated with each identified parent alarm. In some embodiments, the parent alarm to be resolved is determined based on a percentage of child alarms identified in operation 225 in comparison with a corresponding rule from operation 210. For example, in some embodiments, a first parent alarm and a second parent alarm are identified in operation 220. The first parent alarm has two associated child alarms; and the second parent alarm has four associated child alarms. Then, in operation 225, two child alarms related to the first parent alarm are identified and three child alarms related to the second parent alarm are identified. The first parent alarm would have 100% of the corresponding child alarms identified, while the second parent alarm would have 75% of the corresponding child alarms identified. In a situation where the parent alarm to be resolved is selected based on percentage of child alarms identified, the first parent alarm would be determined by the operation 230.

In some instances, an absolute number of child alarms and a percentage of child alarms identified in operation 225 for more than one of the parent alarms identified in operation 220 are equal. In such a situation, the parent alarm to be resolved is determined by the operation 230 to be the parent alarm having an earliest time associated with the corresponding parent alarm from the alarm log received in operation 205. For example, in some embodiments, a first parent alarm and a second parent alarm are identified in operation 220. The first parent alarm has two associated child alarms; and the second parent alarm has two associated child alarms. Then, in operation 225, one child alarm related to the first parent alarm are identified and one child alarm related to the second parent alarm are identified. A time associated with the first parent alarm is thirty minutes prior to a time associated with the second parent alarm. The time associated with the alarm is a time when the fault causing the alarm was initially detected. In this example, both the first parent alarm and the second parent alarm have a same number of total child alarms identified and the same percentage of child alarms identified. However, the first parent alarm has an earlier time than the second parent alarm. In such a situation, the first parent alarm would be determined by the operation 230.

In operation 235, a new incident is generated based on the parent alarm determined in operation 230. The incident includes instructions for resolving the parent alarm. In some embodiments, the instructions are input by a user of the monitoring system, e.g., monitoring system 140 (FIG. 1). In some embodiments, the instructions are generated based on an alarm code associated with the primary fault. In some embodiments, the incident further includes instructions for resolving one or more child alarms associated with the parent alarm. In some embodiments, the instructions are automatically transmitted to either the user or a maintenance crew for implementing the instructions. In some embodiments, the instructions are transmitted wirelessly. In some embodiments, the instructions are transmitted via a wired connection. In some embodiments, the instructions cause a device, such as a mobile device, accessible by the user or maintenance crew to automatically display an alert, such as an audio or visual alert, upon receipt of the instructions. In some embodiments, the incident is placed in a queue for processing based on a priority level of the incident. In some embodiments, the priority level of the incident is set based on a type of alarm code associated with the primary fault. In some embodiments, the priority level of the incident is set based on an equipment type of the primary fault. In some embodiments, multiple criteria are utilized to determine the priority level of the incident.

In some embodiments, an incident log is received. The incident log is a listing of currently open incidents. In some embodiments, the incident log is stored within the monitoring system, e.g., monitoring system 140 (FIG. 1). In some embodiments, the incident log is retrieved from an external device, such as a server. The incident log includes a status of each of the listed incidents. In some embodiments, the incident is listed as either open or closed. An open incident indicates that the instructions have not been completed. In some embodiments, the incident indicates that the instructions have not begun to be implemented. In some embodiments, a closed incident indicates that the instructions have been completed. In some embodiments, a closed incident indicates that the fault has been resolved. In some embodiments, the incident log is retrieved wirelessly. In some embodiments, the incident log is retrieved via a wired connection.

In some embodiments, a determination is made regarding whether the parent alarm identified in operation 230 matches any of the open incidents in the retrieved incident log. In some embodiments, the operation 235 further includes determining whether the work on the instructions associated with a matching incident from the incident log has begun. In some embodiments, in response to a determination that a match exists between the incident log and the identified parent alarm, a priority level of the incident is increased. In response to a determination that a match between the identified parent alarm and the incident log exists, a new incident is not generated. In some embodiments, the incident generated in operation 235 is used to update the incident log for future iterations of the method 200.

In some embodiments, a determination is made regarding whether to update a status of the incident matching the identified parent alarm. The determination is made regarding whether to update the status based on review of the alarm log. In some embodiments, the alarm log is reviewed to determine whether the alarm is continuing to occur. In response to a determination that the alarm is continuing to occur, the incident matching the identified parent alarm remains open; and the method 200 returns to operation 220; pauses; or ceases, as described above with respect to operation 220. In response to a determination that the alarm is not continuing to occur, the method 200 awaits a new version of the alarm log.

One of ordinary skill in the art would understand that the current application is not limited to the explicitly described operations in method 200. In some embodiments, the method 200 includes additional operations. For example, in some embodiments, the method 200 includes transmittal of the incident to a maintenance crew to replace or repair a component of the telecommunication network associated with the identified parent alarm. In some embodiments, at least one operation of the method 200 is omitted. For example, in some embodiments, a functionality of the operation 215 is incorporated into operation 220 and the operation 215 is omitted as a separate step. In some embodiments, an order of operations of the method 200 is changed. For example, in some embodiments, the operation 215 is performed prior to the operation 210. One of ordinary skill in the art would recognize that other modifications are also within the scope of this description.

FIG. 3 is a diagram of a system 300 for identifying recurring alarms in accordance with some embodiments. System 300 includes a hardware processor 302 and a non-transitory, computer readable storage medium 304 encoded with, i.e., storing, the computer program code 306, i.e., a set of executable instructions. Computer readable storage medium 304 is also encoded with instructions 307 for interfacing with external devices, such as base stations 110 (FIG. 1), servers, mobile devices, or other suitable external devices. The processor 302 is electrically coupled to the computer readable storage medium 304 via a bus 308. The processor 302 is also electrically coupled to an input/output (I/O) interface 310 by bus 308. A network interface 312 is also electrically connected to the processor 302 via bus 308. Network interface 312 is connected to a network 314, so that processor 302 and computer readable storage medium 304 are capable of connecting to external elements via network 314. The processor 302 is configured to execute the computer program code 306 encoded in the computer readable storage medium 304 in order to cause system 300 to be usable for performing a portion or all of the operations as described in method 200 (FIG. 2) or with respect to telecommunication network 100 (FIG. 1).

In some embodiments, the processor 302 is a central processing unit (CPU), a multi-processor, a distributed processing system, an application specific integrated circuit (ASIC), and/or a suitable processing unit.

In some embodiments, the computer readable storage medium 304 is an electronic, magnetic, optical, electromagnetic, infrared, and/or a semiconductor system (or apparatus or device). For example, the computer readable storage medium 504 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 304 includes a compact disk-read only memory (CD-ROM), a compact disk-read/write (CD-R/W), and/or a digital video disc (DVD).

In some embodiments, the storage medium 304 stores the computer program code 306 configured to cause system 300 to perform a portion or all of the operations as described in method 200 (FIG. 2) or with respect to telecommunication network 100 (FIG. 1). In some embodiments, the storage medium 304 also stores information needed for performing a portion or all of the operations as described in method 200 (FIG. 2) or with respect to telecommunication network 100 (FIG. 1) as well as information generated during performing a portion or all of the operations as described in method 200 (FIG. 2) or with respect to telecommunication network 100 (FIG. 1), such as a rules parameter 316, an alarm log parameter 318, a selection criteria parameter 320, primary fault parameter 322, an incident log parameter 324 and/or a set of executable instructions to perform a portion or all of the operations as described in method 200 (FIG. 2) or with respect to telecommunication network 100 (FIG. 1). The selection criteria parameter 320 is usable to determine how to select a parent alarm to be resolved, e.g., in operation 230 of method 200 (FIG. 2).

In some embodiments, the storage medium 304 stores instructions 307 for interfacing with external devices. The instructions 307 enable processor 302 to generate instructions readable by the external devices to effectively implement a portion or all of the operations as described in method 200 (FIG. 2) or with respect to telecommunication network 100 (FIG. 1).

System 300 includes I/O interface 310. I/O interface 310 is coupled to external circuitry. In some embodiments, I/O interface 310 includes a keyboard, keypad, mouse, trackball, trackpad, and/or cursor direction keys for communicating information and commands to processor 302.

System 300 also includes network interface 312 coupled to the processor 302. Network interface 312 allows system 300 to communicate with network 314, to which one or more other computer systems are connected. Network interface 312 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described in method 200 (FIG. 2) or with respect to telecommunication network 100 (FIG. 1) is implemented in two or more systems 300, and information such as rules, alarm log, selection criteria, primary fault, or incident log is exchanged between different systems 300 via network 314.

An aspect of this description relates to a system for identifying correlated alarms. The system includes a non-transitory computer readable medium configured to store instructions thereon; and a processor connected to the non-transitory computer readable medium. The processor is configured to execute the instructions for identifying a parent alarm from an alarm log based a plurality of rules, wherein the alarm log comprises a plurality of alarm, and the plurality of alarms contains the identified parent alarm. The processor is configured to execute the instructions for determining whether the plurality of alarms includes a child alarm associated with the identified parent alarm based on the plurality of rules. The processor is configured to execute the instructions for generating an incident in response to a determination that the plurality of alarms includes the child alarm, wherein the incident includes instructions for resolving the parent alarm. In some embodiments, the processor is further configured to execute the instructions for receiving the alarm log; and receiving the plurality of rules. In some embodiments, the processor is further configured to execute the instructions for receiving the plurality of rules from a user. In some embodiments, the processor is further configured to execute the instructions for identifying a plurality of parent alarms from the alarm log based on the plurality of rules. In some embodiments, the processor is further configured to execute the instructions for selecting a target parent alarm from the plurality of parent alarms based on the determination of whether the plurality of alarms includes the child alarm; and generating the incident for resolving the target parent alarm. In some embodiments, the processor is further configured to execute the instructions for selecting the target parent alarm based on a number of child alarms, determined to be in plurality of alarms, associated with each of the plurality of parent alarms, wherein the target parent alarm has a highest number of child alarms amongst the plurality of parent alarms. In some embodiments, the processor is further configured to execute the instructions for selecting the target parent alarm based on a percentage of child alarms, determined to be in plurality of alarms, associated with each of the plurality of parent alarms, wherein the target parent alarm has a highest percentage of child alarms amongst the plurality of parent alarms. In some embodiments, the processor is further configured to execute the instructions for selecting the target parent alarm based on a time that each of the plurality of parent alarms was initiated. In some embodiments, the processor is further configured to execute the instructions for aggregating the plurality of alarms based on the alarm log.

An aspect of this description relates to a method of identifying correlated alarms. The method includes identifying a parent alarm from an alarm log based a plurality of rules, wherein the alarm log comprises a plurality of alarm, and the plurality of alarms contains the identified parent alarm. The method further includes determining whether the plurality of alarms includes a child alarm associated with the identified parent alarm based on the plurality of rules. The method further includes generating an incident in response to a determination that the plurality of alarms includes the child alarm, wherein the incident includes instructions for resolving the parent alarm. In some embodiments, the method further includes receiving the alarm log; and receiving the plurality of rules. In some embodiments, receiving the rule includes receiving the plurality of rules from a user. In some embodiments, the method further includes identifying a plurality of parent alarms from the alarm log based on the plurality of rules; selecting a target parent alarm from the plurality of parent alarms based on the determination of whether the plurality of alarms includes the child alarm; and generating the incident for resolving the target parent alarm. In some embodiments, selecting the target parent alarm includes selecting the target parent alarm based on a number of child alarms, determined to be in plurality of alarms, associated with each of the plurality of parent alarms, wherein the target parent alarm has a highest number of child alarms amongst the plurality of parent alarms. In some embodiments, selecting the target parent alarm includes selecting the target parent alarm based on a percentage of child alarms, determined to be in plurality of alarms, associated with each of the plurality of parent alarms, wherein the target parent alarm has a highest percentage of child alarms amongst the plurality of parent alarms. In some embodiments, selecting the target parent alarm includes selecting the target parent alarm based on a time that each of the plurality of parent alarms was initiated.

An aspect of this description relates to a non-transitory computer readable medium configured to store instructions thereon. The instructions when executed by a process cause the processor to identify a parent alarm from an alarm log based a plurality of rules, wherein the alarm log comprises a plurality of alarm, and the plurality of alarms contains the identified parent alarm. The instructions when executed by a process cause the processor to determine whether the plurality of alarms includes a child alarm associated with the identified parent alarm based on the plurality of rules. The instructions when executed by a process cause the processor to generate an incident in response to a determination that the plurality of alarms includes the child alarm, wherein the incident includes instructions for resolving the parent alarm. In some embodiments, the instructions are further configured to cause the processor to identify a plurality of parent alarms from the alarm log based on the plurality of rules; select a target parent alarm from the plurality of parent alarms based on the determination of whether the plurality of alarms includes the child alarm; and generate the incident for resolving the target parent alarm. In some embodiments, the instructions are further configured to cause the processor to select the target parent alarm based on a number of child alarms, determined to be in plurality of alarms, associated with each of the plurality of parent alarms, wherein the target parent alarm has a highest number of child alarms amongst the plurality of parent alarms. In some embodiments, the instructions are further configured to cause the processor to select the target parent alarm based on a percentage of child alarms, determined to be in plurality of alarms, associated with each of the plurality of parent alarms, wherein the target parent alarm has a highest percentage of child alarms amongst the plurality of parent alarms.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system for identifying correlated alarms, wherein the system comprises:
a non-transitory computer readable medium configured to store instructions thereon; and
a processor connected to the non-transitory computer readable medium, wherein the processor is configured to execute the instructions for:
identifying a parent alarm from an alarm log based a plurality of rules, wherein the alarm log comprises a plurality of alarm, and the plurality of alarms contains the identified parent alarm;
determining whether the plurality of alarms includes a child alarm associated with the identified parent alarm based on the plurality of rules; and
generating an incident in response to a determination that the plurality of alarms includes the child alarm, wherein the incident includes instructions for resolving the parent alarm.

2. The system of claim 1, wherein the processor is further configured to execute the instructions for:
receiving the alarm log; and
receiving the plurality of rules.

3. The system of claim 2, wherein the processor is further configured to execute the instructions for:
receiving the plurality of rules from a user.

4. The system of claim 1, wherein the processor is further configured to execute the instructions for:
identifying a plurality of parent alarms from the alarm log based on the plurality of rules.

5. The system of claim 4, wherein the processor is further configured to execute the instructions for:
selecting a target parent alarm from the plurality of parent alarms based on the determination of whether the plurality of alarms includes the child alarm; and
generating the incident for resolving the target parent alarm.

6. The system of claim 5, wherein the processor is further configured to execute the instructions for:
selecting the target parent alarm based on a number of child alarms, determined to be in plurality of alarms, associated with each of the plurality of parent alarms, wherein the target parent alarm has a highest number of child alarms amongst the plurality of parent alarms.

7. The system of claim 5, wherein the processor is further configured to execute the instructions for:
selecting the target parent alarm based on a percentage of child alarms, determined to be in plurality of alarms, associated with each of the plurality of parent alarms, wherein the target parent alarm has a highest percentage of child alarms amongst the plurality of parent alarms.

8. The system of claim 5, wherein the processor is further configured to execute the instructions for:
selecting the target parent alarm based on a time that each of the plurality of parent alarms was initiated.

9. The system of claim 1, wherein the processor is further configured to execute the instructions for:
aggregating the plurality of alarms based on the alarm log.

10. A method of identifying correlated alarms, wherein the method comprises:
identifying a parent alarm from an alarm log based a plurality of rules, wherein the alarm log comprises a plurality of alarm, and the plurality of alarms contains the identified parent alarm;
determining whether the plurality of alarms includes a child alarm associated with the identified parent alarm based on the plurality of rules; and
generating an incident in response to a determination that the plurality of alarms includes the child alarm, wherein the incident includes instructions for resolving the parent alarm.

11. The method of claim 10, further comprising:
receiving the alarm log; and
receiving the plurality of rules.

12. The method of claim 11, wherein receiving the rule comprises receiving the plurality of rules from a user.

13. The method of claim 10, further comprising:
identifying a plurality of parent alarms from the alarm log based on the plurality of rules;
selecting a target parent alarm from the plurality of parent alarms based on the determination of whether the plurality of alarms includes the child alarm; and
generating the incident for resolving the target parent alarm.

14. The method of claim 13, wherein selecting the target parent alarm comprises:
selecting the target parent alarm based on a number of child alarms, determined to be in plurality of alarms, associated with each of the plurality of parent alarms, wherein the target parent alarm has a highest number of child alarms amongst the plurality of parent alarms.

15. The method of claim 13, wherein selecting the target parent alarm comprises:
selecting the target parent alarm based on a percentage of child alarms, determined to be in plurality of alarms, associated with each of the plurality of parent alarms, wherein the target parent alarm has a highest percentage of child alarms amongst the plurality of parent alarms.

16. The method of claim 13, wherein selecting the target parent alarm comprises:
selecting the target parent alarm based on a time that each of the plurality of parent alarms was initiated.

17. A non-transitory computer readable medium configured to store instructions thereon that when executed by a process cause the processor to:
identify a parent alarm from an alarm log based a plurality of rules, wherein the alarm log comprises a plurality of alarm, and the plurality of alarms contains the identified parent alarm;
determine whether the plurality of alarms includes a child alarm associated with the identified parent alarm based on the plurality of rules; and
generate an incident in response to a determination that the plurality of alarms includes the child alarm, wherein the incident includes instructions for resolving the parent alarm.

18. The non-transistor computer readable medium of claim 17, wherein the instructions are further configured to cause the processor to:
identify a plurality of parent alarms from the alarm log based on the plurality of rules;
select a target parent alarm from the plurality of parent alarms based on the determination of whether the plurality of alarms includes the child alarm; and
generate the incident for resolving the target parent alarm.

19. The non-transistor computer readable medium of claim 18, wherein the instructions are further configured to cause the processor to:
select the target parent alarm based on a number of child alarms, determined to be in plurality of alarms, associated with each of the plurality of parent alarms, wherein the target parent alarm has a highest number of child alarms amongst the plurality of parent alarms.

20. The non-transistor computer readable medium of claim 18, wherein the instructions are further configured to cause the processor to:
select the target parent alarm based on a percentage of child alarms, determined to be in plurality of alarms, associated with each of the plurality of parent alarms, wherein the target parent alarm has a highest percentage of child alarms amongst the plurality of parent alarms.
